(19) United States
(12) Patent Application Publication
(10) Pub. No.: US 2017/0262292 A1
(43) Pub. Date: Sep. 14, 2017

(54) METHOD OF OPERATING EMBEDDED SYSTEM AND CONTROL CHIP THEREOF

(71) Applicant: MStar Semiconductor, Inc., Hsinchu Hsien (TW)

(72) Inventor: Chien Hsing Huang, Hsinchu County (TW)

(21) Appl. No.: 15/363,297

(22) Filed: Nov. 29, 2016

(30) Foreign Application Priority Data
Mar. 11, 2016 (TW) 105107687

(51) Int. Cl. G06F 9/44; G06F 9/54

(52) U.S. Cl. CPC G06F 9/4411; G06F 9/545

(57) ABSTRACT

A method of operating an embedded system including target hardware is provided. An operating system of the embedded system has a user mode and a kernel mode. The method includes: providing a user mode driver, which is executed in the user mode to control the target hardware; providing a kernel mode driver, which is executed in the kernel mode to control the target hardware; receiving an instruction code; and deciding to use one of the user mode driver and the kernel mode driver according to the instruction code to control the target hardware.

This application claims the benefit of Taiwan application Serial No. 105107687, filed Mar. 11, 2016, the subject matter of which is incorporated herein by reference.

### BACKGROUND OF THE INVENTION

Field of the Invention

The invention relates in general to an embedded system, and more particularly to a control chip of an embedded system and an operation method for executing a driver thereof.

Description of the Related Art

System resources of a current embedded system are usually managed with the assistance of an operating system due to diversified functions the embedded system provides. A driver of the embedded system may be executed in a user mode or a kernel mode of the operating system. A driver executed in the user mode includes following advantages. First of all, an inoperable driver in the user mode does not lead to a kernel crash; secondly, a response speed of an application calling a driver in the user mode is faster because switching between a protected mode and a non-protected mode is not required. On the other hand, a driver executed in the kernel mode also features certain advantages. First of all, a more comprehensive support for multitasking of the operating system is provided; secondly, a more all-around support is provided for the operating system in a sleep mode. However, conventionally, whether a driver is to be executed in a user mode or a kernel mode needs to be decided in a compile time of the driver instead of being decided only in a runtime of the system, hence limiting utilization flexibilities of the driver.

### SUMMARY OF THE INVENTION

It is an object of the present invention to provide a method of operating an embedded system and a control chip thereof to enhance driver execution flexibilities for the embedded system.

The present invention discloses a method of operating an embedded system including target hardware. An operating system of the embedded system has a user mode and a kernel mode. The method includes: providing a user mode driver, which is executed in the user mode to control the target hardware; providing a kernel mode driver, which is executed in the kernel mode to control the target hardware; receiving an instruction code; and deciding to use one of the user mode driver and the kernel driver mode according to the instruction code to control the target hardware.

The present invention further discloses a control chip of an embedded system. The control chip, controlling target hardware of the embedded system, includes: a processing unit, executing an operating system to perform a function of the embedded system, the operating system having a user mode and a kernel mode; and a memory, coupled to the processing unit, storing a system program of the embedded system, including: a user mode driver that is executed in the user mode to control the target hardware, a kernel mode driver that is executed in the kernel mode to control the target hardware, and a determining module. The processing unit decides to use one of the user mode driver and the kernel mode driver to control the target hardware according to an instruction code corresponding to the target hardware.

The method of operating an embedded system and the control chip of the present invention allow the embedded system to decide whether to execute the user mode driver or the kernel mode driver in the runtime. As opposed to the prior art, the present invention is not required to decide to execute a driver in the user mode or the kernel mode in advance, thereby enhancing driver execution flexibilities for the embedded system.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a partial function block diagram of an embedded system;

FIG. 2 is a schematic diagram of a user space and a kernel space of a system program according to an embodiment of the present invention;

FIG. 3 is a flowchart of integrating a function interface of a user mode driver and a kernel driver mode according to an embodiment of the present invention; and

FIG. 4 is a flowchart of selecting to use a user mode driver or a kernel mode driver to control hardware according to an embodiment of the present invention.

### DETAILED DESCRIPTION OF THE INVENTION

The disclosure of the application includes a method of operating an embedded system and a control chip thereof. The technical features of the embodiments of the disclosure are examples for person skilled in the art to understand the disclosure and not to limit the disclosure. Besides, in possible implementation, one skilled person in the art may choose equivalent elements or steps to implement the disclosure based on the disclosure of the application. That is, the implementation of the disclosure is not limited by the embodiments disclosed in the disclosure.

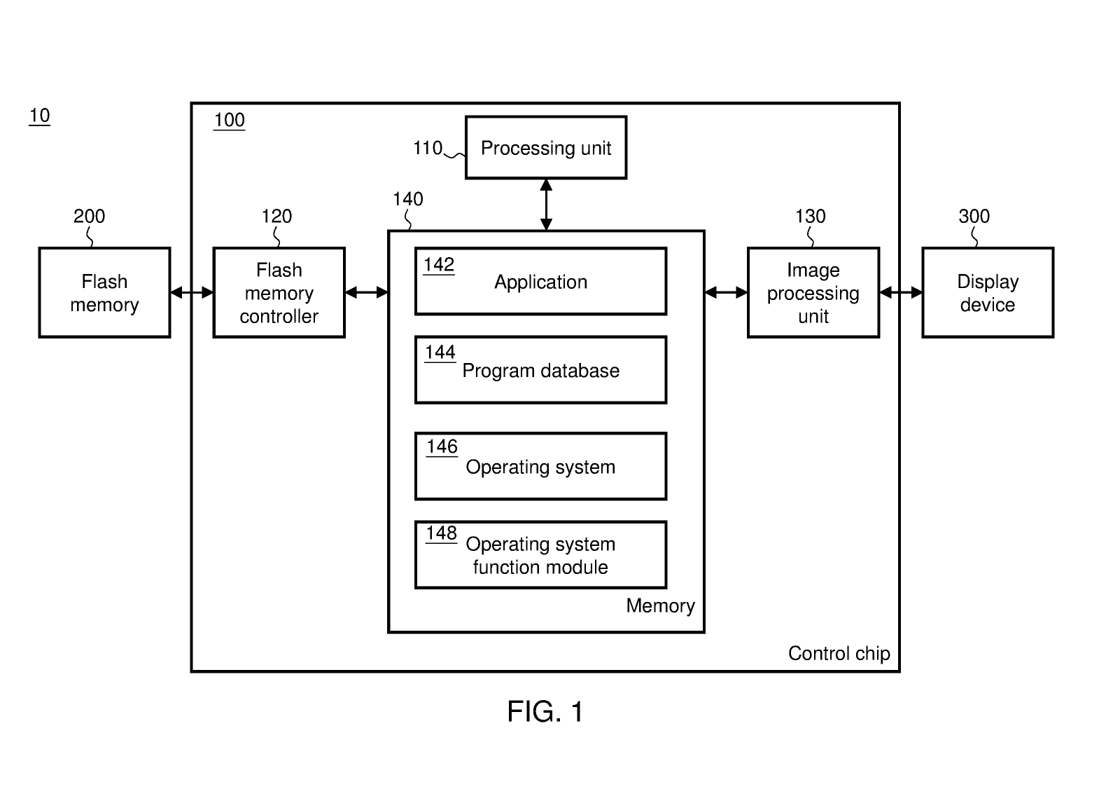

FIG. 1 shows a partial function block diagram of an embedded system. For example, the embedded system 10 is a television, a handheld electronic device (e.g., a cell phone or a tablet computer), or other consumer electronic devices, and includes a control chip 100, a flash memory 200 and a display device 300. The flash memory 200 stores a system program that the control chip 100 requires for performing functions of the embedded system 10. A processing unit 110 of the control chip 100 reads the system program from the flash memory 200 via a flash memory controller 120, and loads the system program into the memory 140. The system program includes an application 142, an operating system 146, an operating system function module 148 and a program database 144 for the use of the application 142. The processing unit 110 executes the operating system 146 to provide the embedded system 10 with capabilities for system scheduling, filing system and even multitasking. The operating system function module 148 provides programs, e.g., drivers, which the operating system 146 needs to access system resources. On the other hand, the operating system 146 further provides the control chip 100 with capabilities for executing the application 142. Thus, the embedded system 10 may perform various functions. Some shared resources of the application 142 are stored in the program database 144. When the control chip 100 wishes to control the display device 300, e.g., displaying an image on the display device 300, the processing unit 110 may execute a driver of the display device 300 to directly render the image on the display device 300, or to display the image having been processed by an image processing unit 130 on the display device 300.

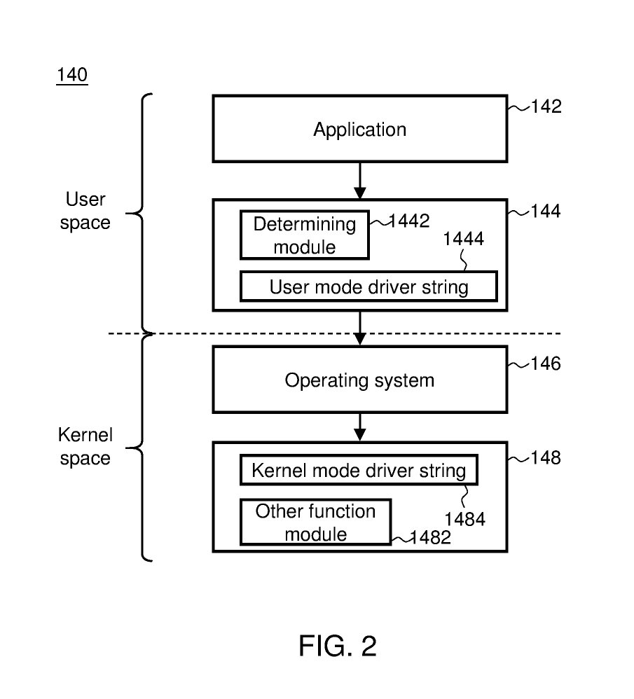

FIG. 2 shows a schematic diagram of a user space and a kernel space in a system program of the present invention. When the system program of the present invention is loaded into the memory 140, the system program is selectively loaded into two independent virtual memory spaces, i.e., the user space and the kernel space. For example, all user mode drivers are loaded into the user space, whereas all kernel mode drivers are loaded into the kernel space. The user space includes the application 142 and the program database 144; the kernel space includes the operating system 146 and the system function module 148. When the operating system 146 is executed, it may be executed in the user mode or the kernel mode. In the user mode, only data and programs in the user space can be accessed; in the kernel mode, only data and programs in the kernel space can be accessed. In one embodiment of the present invention, the user space and the kernel space are respectively registered with a user mode driver and a kernel mode driver of the display device 300. More specifically, the user mode driver of the display device 300 is registered in a user mode driver string 1444 in the program database 144, and the kernel mode driver of the display device 300 is registered in a kernel mode driver string 1484 in the operating system function module 148. In addition to the kernel mode driver string 1484, the operating system function module 148 further includes other function modules 1482 that the embedded system 10 needs.

Conventionally, a method for generating a driver of a system includes steps of: a) writing a program code according to a function and characteristics of target hardware and whether the target hardware is to be used in the user mode or the kernel mode; 2) compiling the program code to obtain a driver logic for controlling the target hardware; and 3) registering the driver logic to obtain a driver. In step (3), a user mode driver is obtained if the driver logic to be used in the user mode is registered in the user space, and a kernel mode driver is obtained if the driver logic to be used in the kernel mode is registered in the kernel space. Further, given that the compiled driver logic is registered in different registration spaces, the program code generated in step (1) may use different function interfaces even it may correspond to a function for the same task. For example, to obtain a user mode driver in step (3), the program code needs to be written in step (1) using a function interface conforming to the user space, and the same applies to the kernel mode driver. Functions that corresponding to the same tasks but different interfaces include a copy function and a memory allocation function.

To allow the embedded system 10 to more smoothly choose between the user mode driver and the kernel mode driver during the runtime, a function that corresponds to the same tasks but different interfaces is first integrated and then registered. Thus, the embedded system 10 may use the same function interface to call for the function corresponding to the same task, thereby enhancing the convenience for executing a driver when the embedded system 10 is executed.

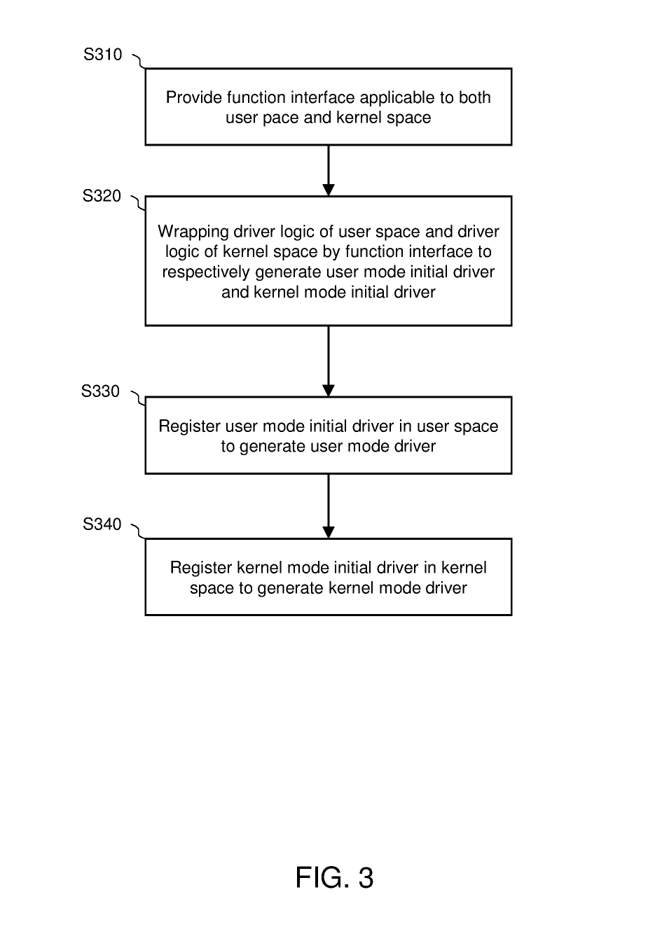

FIG. 3 shows a flowchart of integrating a function interface of a user mode driver and a kernel mode driver. To provide a function corresponding to the same task but different interfaces, a function interface that is applicable to both the user space and the kernel space is provided (step S310). For the driver logic of the user space and the driver logic of the kernel space, because there may be more than one function that corresponds to the same task but different interfaces, more than one function interface may be provided in step S310. Next, the driver logic of the user space and the driver logic of the kernel space are wrapped by the function interface to generate a user mode initial driver and a kernel mode initial driver, respectively (step S320). The user mode initial driver is registered in the user space to generate a user mode driver (step S330), and the kernel mode initial driver is registered in the kernel space to generate a kernel mode driver (step 340). It should be noted that, step 340 may be performed before step S330. More specifically, as the user mode initial driver and the kernel mode initial driver use the same interface function as a calling interface, the same interface function may be used to call the user mode driver or the kernel mode driver subsequently for either the user mode or the kernel mode, to accordingly perform the same operations.

In practice, the embedded system 10 includes other types of hardware in addition to the display device 300, and such other hardware also needs corresponding drivers. Thus, the embedded system 10 includes a plurality of user mode drivers and a plurality of kernel mode drivers. These user mode drivers exist in the user mode driver string 1444 in form of a linked list, and these kernel mode drivers exist in the kernel mode driver string 1484 in form of a linked list. In either of the user mode driver string 1444 and the kernel mode driver string 1484, the drivers have respective identifiers. In one embodiment of the present invention, in the registration process in step S330 and step S340, the user mode initial driver and the kernel mode initial driver are respectively registered in the user space and the kernel space using the same identifier. That is to say, a driver corresponding to the same hardware has the same identifier in both the user mode driver string 1444 and the kernel mode driver string 1484. In one embodiment, for example but not limited to, the identifier may be an order of the driver in a linked list. An advantage of such design is that, the embedded system 10 may find a user mode driver or a kernel mode driver from the user mode driver string 1444 or the kernel mode driver string 1484 based on requirements.

In one embodiment of the present invention, when the embedded system 10 needs to operate certain target hardware (e.g., the display device 300 or other another type of hardware), a handle code of the target hardware is obtained according to an instruction code, and the corresponding driver is operated according to an operation instruction (e.g., a copy instruction) and the handle code to control the target hardware. For example, the corresponding driver may be a user mode driver or a kernel mode driver based on requirements.

In one embodiment, assuming that the identifiers of the drivers of the target hardware in the user mode driver string 1444 and the kernel mode driver string 1484 are both 0x00000001 (i.e., the 1^{st} order in the user mode driver string 1444 and the kernel mode driver string 1484), the instruction code corresponding to the user mode is also determined as 0x00000001 by the processing unit 110, and the instruction code corresponding to the kernel mode is 0x80000001. That is to say, the two only differ by the most significant bit (MSB). Thus, the corresponding user mode driver can be identified according to the instruction code 0x00000001 in the user mode, and the corresponding kernel mode driver can be identified according to the instruction code 0x80000001 in the kernel mode.

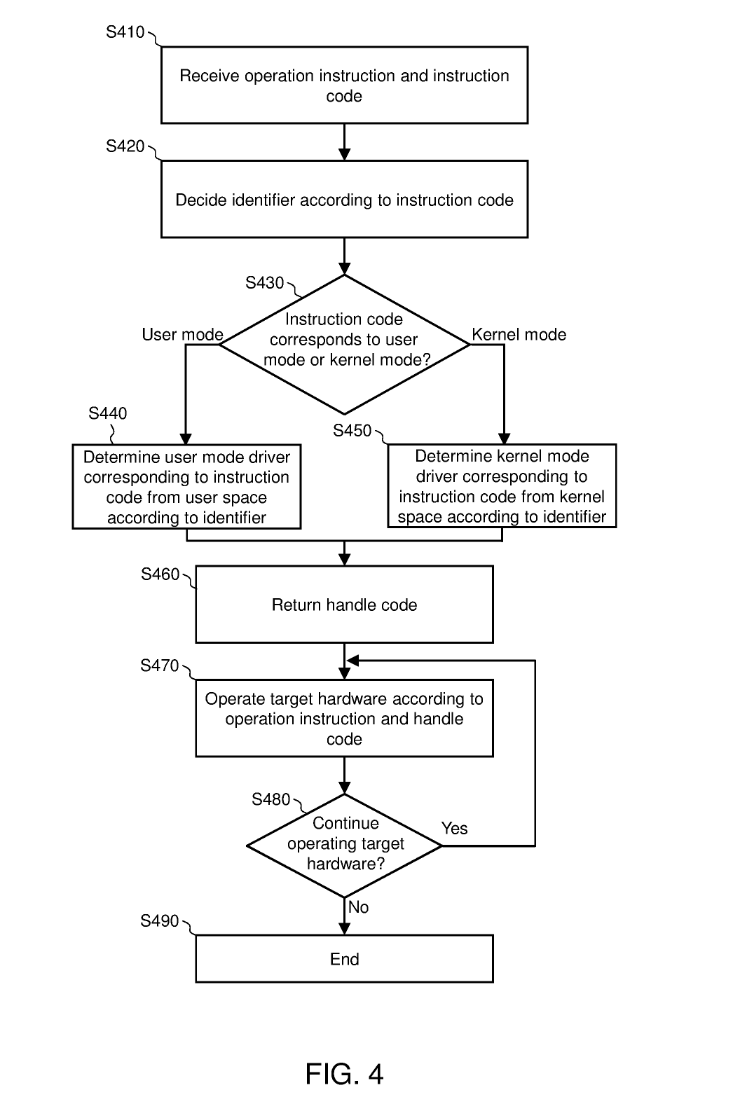

FIG. 4 sows a flowchart of selecting a user mode driver or a kernel mode driver to control hardware according to an embodiment of the present invention. An operation instruction and an instruction code are received (step S410). An identifier is decided according to the instruction code (step S420). In practice, the determining module 1442 may directly use a look-up table (LUT) to decide an identifier corresponding to an instruction code. For example, instruction codes 0x00000001 and 0x80000001 both correspond to an identifier 0x00000001. Alternatively, when the instruction codes corresponding to the user mode and the kernel mode only differ by the MSB, the determining module 1442 may further shield the MSB of an instruction code by a mask to directly obtain the identifier. Next, the determining module 1442 determines whether the instruction code corresponds to the user mode or the kernel mode (step S430). In practice, the determining module 1442 is controlled by the processing unit 110, and may be used to directly use the LUT to determine whether the instruction code corresponds to the user mode or the kernel mode. For example, an instruction code 0x00000001 corresponds to the user mode, and an instruction code 0x80000001 corresponds to the kernel mode. Alternatively, the determining module 1442 may apply a mask and compare only the MSB of an instruction code, e.g., 0 corresponds to the user mode and 8 corresponds to the kernel mode. It should be noted that, orders for performing steps S420 and S430 may be swapped, or steps S420 and S430 may be performed simultaneously. Further, when step S430 is performed before step S420, as whether the user mode driver or the kernel mode driver is to be selected is known, the instruction code may be directly mapped as the identifier. For example, when step S430 determines to select the user mode driver, the mapping mechanism directly regards the instruction code as the identifier instead of further performing a conversion. For example, when step S430 determines to select the kernel mode driver, the instruction code 0x80000001 is directly mapped as 0x00000001 as the identifier.

After the identifier is decided and whether the instruction code corresponds to the user mode or the kernel mode is determined, a driver corresponding to the instruction code is determined from the corresponding space (i.e., the user mode corresponds to the user space and the kernel mode corresponds to the kernel space) according to the identifier (step S440 or step S450). That is to say, step S440 is performed when the instruction code corresponds to the user mode, and the corresponding user mode driver is determined from the user mode driver string 1444 according to the identifier. On the other hand, step S450 is performed when the instruction code corresponds to the kernel mode, and the corresponding kernel mode driver is determined from the kernel mode driver string 1484 according to the identifier.

After step S440 or step S450 is complete, a handle code is returned (step S460). More specifically, step S410 to step S460 are performed through an open instruction. During the operation process, the processing unit 110 first defines a first memory space and a second memory space (not shown) from the memory 140 according to the open instruction. The first memory space belongs to the user space, and the second memory space belongs to the kernel space. Next, according to the user mode driver and the kernel mode driver determined by the decided identifier, data of the corresponding user mode driver is loaded into the first memory space, and data of the corresponding kernel mode driver is loaded into the second memory space. The returned handle code includes a memory address. When the instruction code corresponds to the user mode, the memory address points to the first memory space; when the instruction code corresponds to the kernel mode, the memory address points to the second memory space. Subsequent operations on the target hardware are performed directly based on the operation instruction and the handle code (step S470) without any further determination. More specifically, the embedded system 10 directly performs the operation instruction according to the user/kernel mode previously selected and the contents recorded in the first/second memory space. Further, in one preferred embodiment, according to the user mode driver and the kernel mode driver determined based on the decided identifier, the processing unit 110 defines the first memory space (the user space) or the second memory space (the kernel space) in the memory 140 according to only the open instruction, and perform the subsequent process.

Next, it is determined whether to continue operating the target hardware (step S480). Step S470 is iterated when the target hardware is to be continually operated (a determination result in step S480 is affirmative), and associated operations are performed directly according to the operation instruction and the handle code. Otherwise (the determination result of step S480 is negative), the current operation on the target hardware ends (step S490). More specifically, if the target hardware is no longer to be operated, the value of the handle code may be cleared by a close instruction, and the foregoing first/second memory space may then be released.

Even during the runtime of the embedded system 10, the present invention is capable of dynamically deciding whether to use a kernel mode driver or a user mode driver for the target hardware. For example, for the same target hardware, by exiting the user mode driver and then initializing the kernel mode driver, switching between the user mode driver and the kernel mode driver can be easily completed. Alternatively, a user may define a mode corresponding to each operation through a text file, and the embedded system 10 may read the text file to accordingly generate the corresponding instruction code for subsequent operations.

In conclusion, the present invention provides an embedded system with flexibilities in selecting a driver to effectively exercise respectively features of a user driver mode driver and a kernel mode driver. For example, when a system needs to immediately operate the target hardware, the kernel mode driver may be selected to obtain a complete support of the operating system. However, when the system needs to frequently operate the target hardware, the user mode driver may be selected, so as to prevent the frequent switching between the protected mode and the non-protected mode from dragging the system performance.

One person skilled in the art can understand details and variations of the methods in FIG. 3 and FIG. 4 based on the disclosure associated with the devices in FIG. 1 and FIG. 2. While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of operating an embedded system, the embedded system comprising target hardware, an operating system of the embedded system having a user mode and a kernel mode, the method comprising:
providing a user mode driver, which is executed in the user mode to control the target hardware;
providing a kernel mode driver, which is executed in the kernel mode to control the target hardware;
receiving an instruction code; and
deciding to use one of the user mode driver and the kernel mode driver according to the instruction code to control the target hardware.

2. The method according to claim 1, further comprising:
generating a user mode initial driver and a kernel mode initial driver corresponding to the target hardware according to a function interface;
registering the user mode initial driver in a user space in a memory space of the embedded system to obtain the user mode driver; and
registering the kernel mode initial driver in a kernel space in the memory space of the embedded system to obtain the kernel mode driver;
wherein, the user mode driver and the kernel mode driver control a same task of the target hardware.

3. The method according to claim 2, wherein the user mode initial driver and the kernel mode initial driver are respectively registered in the user space and the kernel space by using a same identifier.

4. The method according to claim 3, wherein the identifier corresponds to an order in a linked list when the user mode initial driver is registered in the user space.

5. The method according to claim 1, wherein the step of deciding to use one of the user mode driver and the kernel mode driver according to the instruction code is performed according to a most significant bit of the instruction code.

6. The method according to claim 1, further comprising:
obtaining a handle code according to the instruction code, the handle code pointing to a memory space that stores data corresponding to one of the user mode driver and the kernel mode driver.

7. The method according to claim 6, further comprising:
controlling the target hardware according to the data.

8. The method according to claim 1, further comprising:
during a runtime of the embedded system, exiting one of the user mode driver and the kernel mode driver and initializing the other of the two to switch one of the user mode driver and the kernel mode driver to control the target hardware.

9. A control chip of an embedded system, adapted to control target hardware of the embedded system, comprising:
a processing unit, executing an operating system to perform functions of the embedded system, the operating system having a user mode and a kernel mode; and
a memory, coupled to the processing unit, storing a system program of the embedded system, comprising:
a user mode driver, executed in the user mode to control the target mode;
a kernel mode driver, executed in the kernel mode to control the target hardware; and
a determining module;
wherein, the processing unit controls the determining module to decide to use one of the user mode driver and the kernel mode driver according to an instruction code corresponding to the target hardware to control the target hardware.

10. The control chip according to claim 9, wherein the processing unit further generates a user mode initial driver and a kernel mode initial driver corresponding to the target hardware according to a function interface.

11. The control chip according to claim 10, wherein the memory comprising a user space and a kernel space, and the processing unit further registers the user mode initial driver in the user space to obtain the user mode driver and registers the kernel mode initial driver in the kernel space to obtain the kernel mode driver.

12. The control chip according to claim 11, wherein the user mode driver and the kernel mode driver control a same task of the target hardware.

13. The control chip according to claim 11, wherein the processing unit respectively registers the user mode initial driver and the kernel mode initial driver in the user space and the kernel space by using a same identifier.

14. The control chip according to claim 13, wherein the identifier corresponds to an order in a linked list when the user mode initial driver is registered in the user space.

15. The control chip according to claim 9, wherein the processing unit controls the determining module to decide to use one of the user mode driver and the kernel mode driver according a most significant bit (MSB) of the instruction code to control the target hardware.

16. The control chip according to claim 9, wherein the processing unit further controls the determining module to obtain a handle code according to the instruction code, and the handle code points to a memory space that stores data corresponding to one of the user mode driver and the kernel mode driver.

17. The control chip according to claim 16, wherein the control chip further controls the target hardware according to the data.
